(19) United States
(12) Patent Application Publication
(10) Pub. No.: US 2002/0081467 A1
(43) Pub. Date: Jun. 27, 2002

(54) Method for operating a liquid-cooled fuel cell battery, and associated fuel cell battery

(76) Inventors: Guenter Luft, Lauf (DE); Konrad Mund, Uttenreuth (DE); Rittmar Von Helmolt, Mainz (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/992,339

(22) Filed: Nov. 19, 2001

Related U.S. Application Data
(63) Continuation of application No. PCT/DE00/01473, filed on May 11, 2000.

(30) Foreign Application Priority Data
May 19, 1999 (DE) 199 229 23.6

(51) Int. Cl. H01M 8/04

(52) U.S. Cl. 429/13; 429/26; 429/24

(57) ABSTRACT

A liquid-cooled fuel cell battery and a method for operating such a battery includes reducing the heat capacity of the fuel cell battery at a start time by removing at least some of the cooling liquid from the cooling system when the battery is being switched off to improve the starting performance of the battery.

### CROSS-REFERENCE TO RELATED APPLICATION:

This application is a continuation of copending International Application No. PCT/DE00/01473, filed May 11, 2000, which designated the United States.

### BACKGROUND OF THE INVENTION

1. Field of the Invention

The invention relates to a method for operating a liquid-cooled fuel cell battery, which, in particular, improves the starting performance of the battery compared to the prior art systems. In addition, the invention also relates to a fuel cell battery suitable for carrying out the method.

German, Non-Prosecuted Patent Application DE 19 914 249 A1, which is not a prior publication, proposed a fuel cell battery with heating, the heating including an integrated heating element that releases heat when it is started in order, for example, to heat up the membrane and/or the fuel cell unit. The heat capacity of the fuel cell remains unchanged.

Japanese Patent document 06-223855 A discloses a fuel cell system that includes inlets and outlets for a coolant that circulates in lines. A gas displaces the coolant out of the fuel cells when it is being switched off. The method is intended to prevent water, which is the coolant that is preferably used, from freezing.

Japanese Patent document 11-273705 A and Japanese Patent document 11-273704 A describe methods for operating fuel cells, in which, once again, water as coolant is removed from the fuel cells when they are being switched off and the water is stored separately.

Furthermore, Japanese Patent document 02-075165 and Japanese Patent document 02-132769 A disclose fuel cell systems in which, in the starting phase, a temperature-controlled medium is added to the cooling liquid.

Finally, British Patent No. GB 1 221 536 A, corresponding to U.S. Pat. No. 3,576,677 to Keating Jr., et al., U.S. Pat. No. 5,316,870 A to Ohga, and U.S. Pat. No. 4,464,444 to Mikawa disclose fuel cell systems for the generation of electrical energy. In the systems, heat generated during operation can be stored respectively and used for other purposes, in particular, when heating the cooling liquid. The dynamics of the processes are not considered in the prior art.

The rate at which a fuel cell battery can be heated depends on its heat capacity, and, specifically, such that a battery with a lower heat capacity can be heated more rapidly than a battery with a high heat capacity. When a battery is used for a mobile application, it is desirable for the heat-up phase to be as short as possible.

### SUMMARY OF THE INVENTION

It is accordingly an object of the invention to provide a method for operating a liquid-cooled fuel cell battery, and associated fuel cell battery, that overcomes the hereinafore-mentioned disadvantages of the heretofore-known devices and methods of this general type and that can be started quickly and with the minimum possible outlay on energy, in particular, after a prolonged period of inactivity. For such a purpose, a suitable battery is provided with a reduced heat capacity, in particular, at the starting time.

With the foregoing and other objects in view, there is provided, in accordance with the invention, a method for operating a liquid-cooled fuel cell battery having a fuel cell stack including at least one fuel cell unit with a cooling system, including the steps of removing cooling liquid from the cooling system and storing the cooling liquid in at least one of a thermally insulated reservoir and a heatable reservoir when the fuel cell battery is being switched off, having the fuel cell stack contain less cooling liquid when the fuel cell battery is not operating as compared to when the fuel cell battery is operating, and introducing the cooling liquid into the cooling system at a point in time including one of the group consisting of before starting the fuel cell battery and during restarting of the fuel cell battery.

The invention relates to a method for operating a liquid-cooled fuel cell battery in which the cooling liquid is removed from the fuel cell stack before the battery is started, so that, when the battery is not operating, the stack contains less cooling liquid than when it is operating. Advantageously, the cooling liquid that is removed from the cooling system is stored in a thermally insulated and/or heatable reservoir when the battery is not operating, where it is available as optionally temperature-controlled cooling liquid for operation of the fuel cell battery after it has been restarted.

With the objects of the invention in view, there is also provided a liquid-cooled fuel cell battery, including at least one fuel cell unit, a collection reservoir for holding a cooling liquid, and a cooling system for cooling the cooling liquid, the cooling system fluidically connected to the at least one fuel cell unit and including at least one outlet and at least one inlet each fluidically connected to the collection reservoir to permit the cooling liquid to flow out of the cooling system and into the reservoir after the battery is switched off and to flow back into the cooling system after the battery is started and/or during starting of the battery.

In accordance with another feature of the invention, the fuel cell battery has a fuel cell stack including at least one fuel cell unit, and the fuel cell stack contains less cooling liquid when the fuel cell battery is not operating as compared to when the fuel cell battery is operating.

In accordance with a further feature of the invention, the inlet and outlet of the cooling system may coincide, so that the same opening that is the inlet when the cooling system is being filled with cooling liquid is also used as the outlet when the system is being switched off. The outlet is preferably located at the lowest point in the cooling system so that, when the outlet is open, the cooling liquid flows out of the cooling system without it being necessary to use a pump or similar device.

In accordance with an added mode of the invention, the reservoir is heated and temperature of the cooling liquid for restarting is controlled using waste heat from one of a reformer and another fuel cell unit.

In accordance with an additional mode of the invention, cooling liquid still present in the fuel cell battery is removed before restarting and the removed cooling liquid is replaced with temperature-controlled cooling liquid.

In accordance with yet another mode of the invention, cooling liquid is provided to the cooling system at a higher temperature than the fuel cell stack and heating the fuel cell stack with the cooling liquid.

In accordance with yet a further mode of the invention, the cooling liquid is replaced with a gas when the fuel cell battery is being switched off.

In accordance with yet an added feature of the invention, the cooling system has a gas-introduction device for introducing gas into the cooling system.

In accordance with yet an additional feature of the invention, the reservoir is thermally insulated.

In accordance with again another feature of the invention, the reservoir includes a heater for heating the cooling liquid in the reservoir.

In accordance with again a further feature of the invention, the outlet is connected to a collection reservoir so that the coolant is stored in the reservoir while the battery is not operating. In such a case, it is preferable for the collection reservoir to have a pump or similar device so that, after the battery has been started, the cooling system can be quickly refilled with cooling liquid.

In accordance with again an added feature of the invention, the cooling system has a plurality of outlets, for example, one outlet for each fuel cell unit. In such a case, it is preferable for each outlet to be associated with a reservoir.

Depending on the particular embodiment of the invention, in accordance with a concomitant feature of the invention, the reservoir/reservoirs may be disposed inside or outside the fuel cell battery.

Further details and advantages of the invention will emerge from the following description of exemplary embodiments in combination with the patent claims.

### DESCRIPTION OF THE PREFERRED EMBODIMENTS

The basis for the description of the invention uses a conventional fuel cell with a high-temperature membrane (HTM) configured as an HT-PEM fuel cell, which for practical operation, form a fuel cell battery. As such, in the context of the invention, there is no need to illustrate such a fuel cell battery in drawings.

The term fuel cell battery refers to the entire fuel cell system, which includes at least one stack with at least one fuel cell unit, the corresponding process gas supply and outlet passages, the end plates, and the cooling system with cooling liquid. The term stack refers to the assembly of at least one fuel cell unit together with the associated lines and at least part of the cooling system.

The cooling system of the fuel cell battery includes a gas line through which gas can be introduced into the cooling system. As such, it is advantageous if the gas line has at least one valve, so that, under certain circumstances, the gas can be introduced at elevated or reduced pressure.

According to the method proposed by the invention, the cooling system is vented when the cooling liquid is being drained from the fuel cell battery, i.e., the cooling liquid is replaced by gas, for example, air, under atmospheric pressure in the cooling system.

According to another embodiment of the method, the cooling liquid is blown out of the cooling system by the introduction of gas, i.e., the cooling liquid is replaced by pressurized gas in the cooling system.

The gas that replaces the cooling liquid in the cooling system has a lower heat capacity than the cooling liquid, and, therefore, reduces the overall heat capacity of the fuel cell battery when the cooling liquid has been at least partially removed from the battery. The gas may be air, an air mixture, and/or inert gas.

Preferably, the reservoir for storing the cooling liquid while the fuel cell battery is not operating is thermally insulated so that the stored cooling liquid at least does not cool to below its freezing point.

A phase change material may be connected to the reservoir. The material is selected, for example, such that the phase transition takes place at above the melting point of the cooling liquid, and, in particular, in the temperature range between +5° C. and +80° C.

The reservoir may be heatable. As such, the cooling liquid is heated by supplying heat from an external source immediately before the battery is started. The external heat source is, for example, a heater with a starter battery, a heater provided by a catalytic burner, the use of the waste heat from another unit, for example, a reformer, or a phase change material. A heatable reservoir may also be thermally insulated so that it can be used as a heat store for the heat stored in the cooling liquid.

On the other hand, the reservoir, in particular, in a configuration in which there is only one collection reservoir for the entire stack and, therefore, considerable heat flows into the reservoir when the cooling liquid is drained, may also be connected, for example, releasably, to a unit in which the heat is either stored or utilized. Therefore, the unit may be a heat exchanger, a heat store, and/or a machine.

According to a particular procedure, when the fuel cell battery is being started, the fuel cell stack is heated in the at-rest state, in which the stack has a reduced heat capacity because at least some of the cooling liquid has been replaced by a gas. Generally, the cooling liquid is admitted and/or pumped back into the cooling system when the stack is at the temperature at which it is ready to operate.

If the cooling liquid in the reservoir is at a higher temperature than the fuel cell stack, it may be favorable at a point when starting the fuel cell battery to introduce the cooling liquid, provided that it is still at a higher temperature than the stack, into the cooling system because the cooling system, which is, in fact, a heat exchanger, can be briefly used for the opposite purpose, serving as a heating device for the stack.

The invention makes use of the fact that a liquid-cooled fuel cell battery having a reduced heat capacity can be made ready to start more quickly because it can be heated more quickly than the conventional fuel cell batteries. The invention should, therefore, be of interest, in particular, for mobile applications, in which case, the utilization of the heat of the drained cooling liquid through a releasable connection may also take place when stationary. In the fuel cell battery according to the invention, cooling liquid is removed from the stack before the battery is started so that the stack is heated without cooling liquid, i.e., with a considerably reduced heat capacity. After starting has taken place, the cooling liquid is fed back to the cooling system.

Other features that are considered as characteristic for the invention are set forth in the appended claims.

Although the invention is illustrated and described herein as embodied in a method for operating a liquid-cooled fuel cell battery, and associated fuel cell battery, it is, nevertheless, not intended to be limited to the details set forth because various modifications and structural changes may be made therein without departing from the spirit of the invention and within the scope and range of equivalents of the claims.

The construction and method of operation of the invention, however, together with additional objects and advantages thereof, will be best understood from the description of the specific embodiments.

We claim:

1. A method for operating a liquid-cooled fuel cell battery having a fuel cell stack including at least one fuel cell unit with a cooling system, which comprises:
removing cooling liquid from the cooling system and storing the cooling liquid in at least one of a thermally insulated reservoir and a heatable reservoir when the fuel cell battery is being switched off;
having the fuel cell stack contain less cooling liquid when the fuel cell battery is not operating as compared to when the fuel cell battery is operating; and
introducing the cooling liquid into the cooling system at a point in time including one of the group consisting of before starting the fuel cell battery and during restarting of the fuel cell battery.

2. The method according to claim 1, which further comprises heating the reservoir and controlling temperature of the cooling liquid for restarting using waste heat from one of a reformer and another fuel cell unit.

3. The method according to claim 1, which further comprises removing cooling liquid still present in the fuel cell battery before restarting and replacing the removed cooling liquid with temperature-controlled cooling liquid.

4. The method according to claim 1, which further comprises providing cooling liquid to the cooling system at a higher temperature than the fuel cell stack and heating the fuel cell stack with the cooling liquid.

5. The method according to claim 1, which further comprises replacing the cooling liquid with a gas when the fuel cell battery is being switched off.

6. A liquid-cooled fuel cell battery, comprising:
at least one fuel cell unit;
a collection reservoir for holding a cooling liquid;
a cooling system for cooling the cooling liquid, said cooling system fluidically connected to said at least one fuel cell unit and including at least one outlet and at least one inlet each fluidically connected to said collection reservoir to permit the cooling liquid to flow out of said cooling system and into said reservoir after the battery is switched off and to flow back into said cooling system one of after the battery is started and during starting of the battery.

7. The fuel cell battery according to claim 6, wherein said at least one outlet and said at least one inlet coincide.

8. The fuel cell battery according to claim 6, wherein said at least one outlet is said at least one inlet.

9. The fuel cell battery according to claim 6, wherein:
said cooling system has a lowest point; and
said at least one outlet is disposed at said lowest point.

10. The fuel cell battery according to claim 6, wherein:
said at least one inlet is a plurality of inlets; and
said at least one outlet is a plurality of outlets.

11. The fuel cell battery according to claim 6, wherein said cooling system has a gas-introduction device for introducing gas into said cooling system.

12. The fuel cell battery according to claim 6, wherein said reservoir is thermally insulated.

13. The fuel cell battery according to claim 6, wherein said reservoir includes a heater for heating the cooling liquid in said reservoir.

14. A liquid-cooled fuel cell battery, comprising:
a fuel cell stack including at least one fuel cell unit;
a collection reservoir for holding a cooling liquid; and
a cooling system for cooling the cooling liquid, said cooling system fluidically connected to said at least one fuel cell unit and including at least one outlet and at least one inlet each fluidically connected to said collection reservoir to permit the cooling liquid to flow out of said cooling system and into said reservoir after the battery is switched off and to flow back into said cooling system one of after the battery is started and during starting of the battery, said fuel cell stack containing less cooling liquid when the fuel cell battery is not operating as compared to when the fuel cell battery is operating.

15. The fuel cell battery according to claim 14, wherein said at least one outlet and said at least one inlet coincide.

16. The fuel cell battery according to claim 14, wherein said at least one outlet is said at least one inlet.

17. The fuel cell battery according to claim 14, wherein:
said cooling system has a lowest point; and
said at least one outlet is disposed at said lowest point.

18. The fuel cell battery according to claim 14, wherein:
said at least one inlet is a plurality of inlets; and
said at least one outlet is a plurality of outlets.

19. The fuel cell battery according to claim 14, wherein said cooling system has a gas-introduction device for introducing gas into said cooling system.

20. The fuel cell battery according to claim 14, wherein said reservoir is thermally insulated.

21. The fuel cell battery according to claim 14, wherein said reservoir includes a heater for heating the cooling liquid in said reservoir.
